(19) United States
(12) Patent Application Publication
(10) Pub. No.: US 2008/0074464 A1
(43) Pub. Date: Mar. 27, 2008

(54) LIQUID RECEIVING DEVICE AND LIQUID EJECTING APPARATUS

(75) Inventors: Atsushi SUMII, Shiojiri-shi (JP); Kazuyuki KAGAMI, Okaya-shi (JP); Kazuma OZAKI, Okaya-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/862,106

(22) Filed: Sep. 26, 2007

(30) Foreign Application Priority Data
Sep. 26, 2006 (JP) 2006-261580

(51) Int. Cl. B41J 2/165

(52) U.S. Cl. 347/36

(57) ABSTRACT

The invention provides a liquid receiving device that includes: a liquid receiving portion that receives discharged liquid; and a liquid drain portion that drains the liquid that has flowed from the liquid receiving portion into the liquid drain portion; wherein the liquid receiving portion has an arrangement area where a first liquid absorber that absorbs the discharged liquid is arranged, the arrangement area having a liquid guiding structure that guides the liquid absorbed by the first liquid absorber to the liquid drain portion; and the liquid drain portion has a second liquid absorber that absorbs the liquid that has flowed from the liquid guiding structure, the liquid drain portion having an absorber compression portion that compresses at least a part of the second liquid absorber.

### BACKGROUND

1. Technical Field

The present invention relates to a liquid receiving device that receives discharged liquid and then drains thereof. The invention further relates to a liquid ejecting apparatus that is provided with such a liquid receiving device.

2. Related Art

Some of ink-jet printers of related art can perform “marginless” printing. Such an ink-jet printer, which is an example of various kinds of liquid ejecting apparatuses, is capable of recording ink dots on the entire surface of a sheet of paper, which is an example of various kinds of recording target media, without leaving any paper margin. A platen built in such an ink-jet printer has an ink-receiving portion (i.e., ink catcher), ink-guiding grooves, ink drain paths, and an ink reservoir portion formed therein. The platen functions to support a sheet of paper and to determine its position so that a recording head can perform printing thereon. Any ink drops that have missed the edge portions of a sheet of paper fall on the ink-receiving portion. Then, after landing thereon, guided by the ink-guiding grooves that are formed in the bottom surface of the ink-receiving portion, the ink that is caught by the ink-receiving portion flows into the ink drain paths. The ink is then drained through the ink drain paths to the ink reservoir portion. Finally, an ink absorber provided at the ink reservoir portion absorbs the drained ink. An example of such a configuration is described in JP-A-2003-103849.

A platen of another type of ink-jet printers has recesses for discarding ink drops that have not successfully land on the edge portions of a sheet of paper. Any ink drop that has not successfully land on the edge portions thereof is discarded into the ink-discarding recess. Then, an ink absorber provided in each of the ink-discarding recesses absorbs the discarded ink. An example of such a configuration is described in JP-A-2004-155109. In the former type of ink-jet printers, a large amount of ink flows to reach the ink absorber via the ink-guiding grooves. Similarly, in the latter type of ink-jet printers, a large amount of ink is directly discarded onto the ink absorber provided in the ink-discarding recesses. Therefore, there is a possibility that the drained/discarded ink dries on the surface of the ink absorber to cause undesirable settlement thereon. In order to provide a technical solution to such a problem, JP-A-2005-14422 and JP-A-2005-144809 discloses a certain type of ink-jet printers that prevents the settlement of ink by enhancing the flow-ability (i.e., liquidity) thereof. Specifically, the proposed related art enhances the flow-ability of ink by applying a solvent onto the ink absorber to form an ink flow channel.

Recently, as the size of print target paper is becoming larger, so does the amount of ink drops that fall outside the edges of the print target paper. Accordingly, it is difficult even for such a solvent-applied ink absorber to successfully absorb a large amount of waste ink drops.

### SUMMARY

An advantage of some aspects of the invention is to provide a liquid receiving device that is capable of ensuring a smooth and efficient flow of discharged liquid, which has been caught by a liquid receiving portion thereof, into a liquid drainage portion thereof, and further ensuring a smooth and efficient drainage of the liquid from the liquid drainage portion thereof. In addition thereto, advantageously, the invention further provides a liquid ejecting apparatus that is provided with such a liquid receiving device.

In order to address the above-identified problem without any limitation thereto, the invention provides, as a first aspect thereof, a liquid receiving device including: a liquid receiving portion that receives discharged liquid; and a liquid drain portion that drains the liquid that has flowed from the liquid receiving portion into the liquid drain portion; wherein the liquid receiving portion has an arrangement area where a first liquid absorber that absorbs the discharged liquid is arranged, the arrangement area having a liquid guiding structure that guides the liquid absorbed by the first liquid absorber to the liquid drain portion; and the liquid drain portion has a second liquid absorber that absorbs the liquid that has flowed from the liquid guiding structure, the liquid drain portion having an absorber compression portion that compresses at least a part of the second liquid absorber. In such a configuration, liquid travels through the liquid guiding structure, which facilitates the formation of an initial ink flow channel. In addition thereto, since liquid flows in/along the liquid guiding structure, it is possible to prevent any undesirable spread of the liquid. Therefore, the invention makes it possible to improve the liquid-guiding capability of the liquid receiving portion. Since the absorber compression portion increases the density of the liquid absorber, it is possible to improve the liquid-sucking capability of the liquid drain portion due to a capillary phenomenon; and in addition, it is further possible to reduce liquid retention capability thereof so as to facilitate the drainage of the spilt liquid due to its “water head” (stress) value.

In the configuration of the liquid receiving device according to the first aspect of the invention described above, it is preferable that the liquid guiding structure is configured as a groove or a ridgeline. With such a configuration, it is possible to effectively canalize/guide liquid so that it flows inside the groove or along the ridgeline. In the configuration of the liquid receiving device according to the first aspect of the invention described above, it is preferable that the absorber compression portion can press at least the center of the liquid absorber or in the neighborhood thereof. With such a configuration, it is possible to compress the liquid absorber in a substantially uniform manner. Therefore, it is possible to improve the liquid absorption efficiency and the liquid drainage efficiency of the liquid absorber.

In order to address the above-identified problem without any limitation thereto, the invention provides, as a second aspect thereof, a liquid ejecting apparatus that ejects liquid onto a liquid ejection target medium, the liquid ejecting apparatus being provided with the liquid receiving device having the configuration described above. With such a configuration, it is possible to provide a liquid ejecting apparatus that can offer the above working effects and advantages for any liquid that falls outside the edges of a liquid ejection target medium at the time of marginless ejecting. In addition thereto, the invention makes it possible to provide a liquid ejecting apparatus that can improve liquid collection efficiency.

### BRIEF DESCRIPTION OF THE DRAWINGS

The invention will be described with reference to the accompanying drawings, wherein like numbers reference like elements.

FIG. 1 is a front perspective view that schematically illustrates an example of the general appearance of an ink-jet printer, which is taken as an example of various kinds of liquid ejecting apparatuses according to an embodiment of the invention.

FIG. 2 is a rear perspective view that schematically illustrates an example of the general appearance of the ink-jet printer illustrated in FIG. 1.

FIG. 3 is another front perspective view that schematically illustrates an example of the inner configuration of the ink-jet printer illustrated in FIG. 1.

FIG. 4 is a side sectional view that schematically illustrates an example of the inner configuration of the ink-jet printer illustrated in FIG. 1.

FIG. 5 is a perspective view that schematically illustrates an example of a platen and its peripheral portion of the ink-jet printer illustrated in FIG. 1 viewed from the upstream side of a paper transport channel.

FIG. 6 is a sectional view of the platen taken along the line VI-VI of FIG. 5.

FIG. 7 is a perspective view that schematically illustrates an example of the essential part of an ink receiving device of the ink-jet printer illustrated in FIG. 1.

FIG. 8 is an enlarged plane view of the portion VIII illustrated in FIG. 7.

FIG. 9 is an enlarged perspective view of the portion IX illustrated in FIG. 8.

### DESCRIPTION OF EXEMPLARY EMBODIMENTS

With reference to the accompanying drawings, an exemplary embodiment of the invention is explained below. Although the invention is described below while explaining an exemplary embodiment thereof, the specific embodiment described below is not intended to limit the scope of the invention recited in the appended claims and thus should in no case be understood to restrict thereof; nor is it always necessary to encompass all of combination(s) of features discussed in the following embodiment as means for solving the problem identified by the invention.

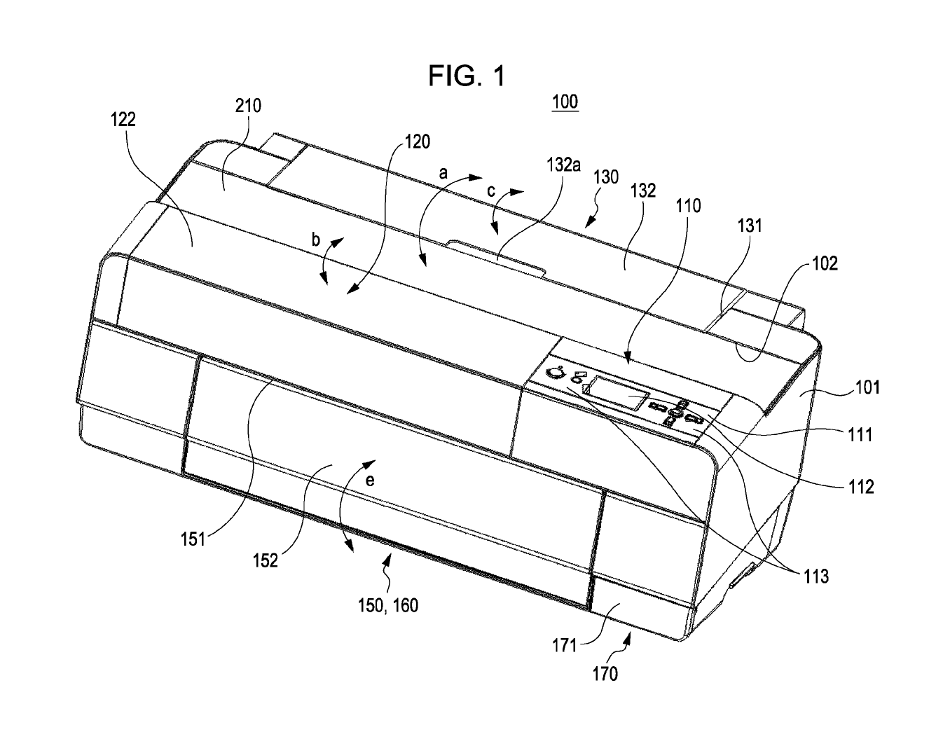

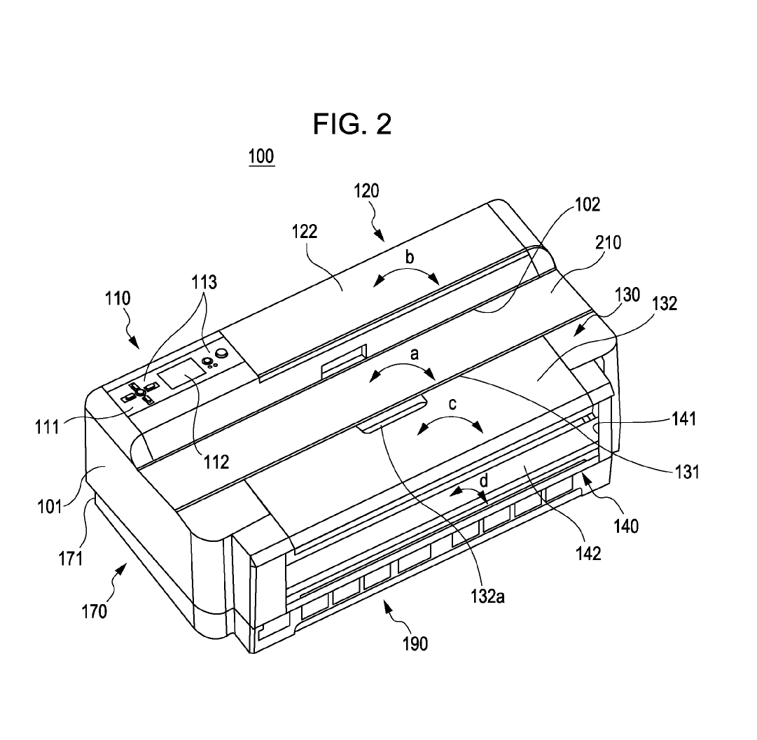

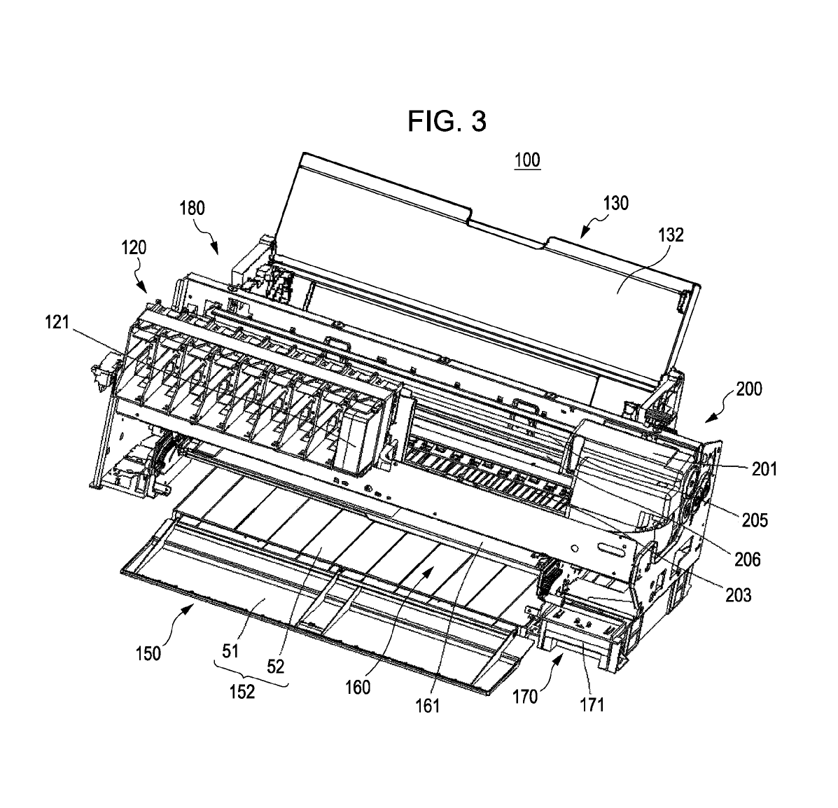

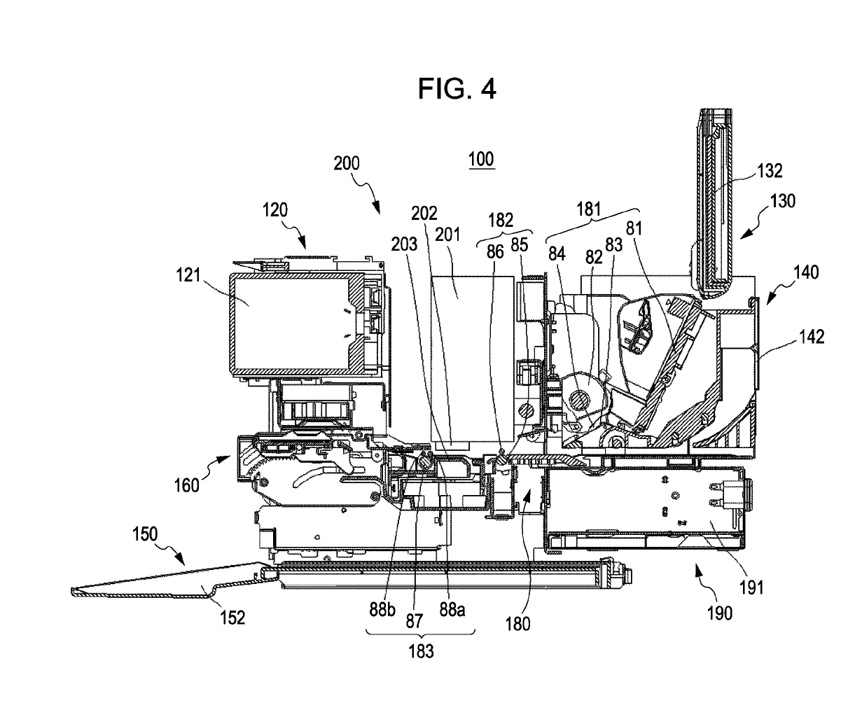

FIG. 1 is a front perspective view that schematically illustrates an example of the general appearance of an ink-jet printer, which is taken as an example of various kinds of liquid ejecting apparatuses according to an embodiment of the invention. FIG. 2 is a rear perspective view that schematically illustrates an example of the general appearance of the ink-jet printer illustrated in FIG. 1. FIG. 3 is another front perspective view that schematically illustrates an example of the inner configuration of the ink-jet printer illustrated in FIG. 1. FIG. 4 is a side sectional view that schematically illustrates an example of the inner configuration of the ink-jet printer illustrated in FIG. 1. An ink-jet printer 100, which is taken as an example of a liquid ejecting apparatus in this specification as described above, has a function to perform printing by means of ink on a variety of cut papers, which are single sheets of paper, having various paper sizes including but not limited to L size, 2L size, postcard size, JIS A4 size, which conforms to the JIS Standards, A3 plus (oversize), and A2 size. In the following description, such a variety of cut papers are simply referred to as “paper”, which should be understood as an example of various kinds of liquid ejection target media.

As illustrated in FIG. 1 and FIG. 2, the entire components of the ink-jet printer 100 are encased in a housing 101 that has the shape of a substantially rectangular parallelepiped. As illustrated in FIG. 1, an operation unit 110 is provided on the front-right portion of the upper surface of the housing 101. On the other hand, a cartridge attachment unit (i.e., cartridge accommodation unit) 120 is provided at the front-left space of the ink-jet printer 100, which is under the upper surface of the housing 101. A first rear paper-feed unit 130 is provided on the rear of the upper surface of the housing 101 shown in FIG. 1. As illustrated in FIG. 2, a second rear paper-feed unit 140 is provided at the rear portion of the ink-jet printer 100. A paper-eject unit 150 and a front paper-feed unit 160 are provided at the front-center portion of the ink-jet printer 100 illustrated in FIG. 1. A discarded ink collection unit 170 is provided at the front-right portion of the ink-jet printer 100 illustrated in FIG. 1. As its inner components, the ink-jet printer 100 is provided with a paper transport unit 180 shown in FIGS. 3 and 4, a control unit 190 shown in FIGS. 2 and 4, and a recording unit 200 shown in FIGS. 3 and 4. It should be noted that the recording unit 200 contains characterizing components according to the present invention.

As illustrated in FIGS. 1 and 2, a rectangular opening portion 102 is formed in the upper surface of the housing 101 between the operation unit 110/cartridge attachment unit 120 and the first rear paper-feed unit 130. A printer cover 210 that has the shape of a substantially rectangular flat board covers the rectangular opening portion 102. The printer cover 210 is attached to the ink-jet printer 100 in such a manner that it can turn in a direction shown in these figures by the arrow “a” around its rotation axis provided at the rear end thereof. After lifting the printer cover 210 so as to expose the opening portion 102, a user can perform various kinds of maintenance work on the inner mechanical components of the ink-jet printer 100 such as the paper transport unit 180, the recording unit 200, or the like through the opening portion 102 in an easy manner.

As illustrated in FIGS. 1 and 2, the operation unit 110 has an operation panel 111 that has a substantially rectangular shape. A liquid crystal panel 112, which displays the operation status of the ink-jet printer 100 or other similar information, is provided at the substantially center region of the operation panel 111. Various kinds of operation buttons 113 are provided both to the left and to the right of the liquid crystal panel 112. These operation buttons 113 include, without any limitation thereto, a power switch button for turning the power of the ink-jet printer 100 ON/OFF, manipulation buttons for performing a paper edge detection, performing an ink-flushing operation, or performing other manipulation tasks, and signal processing buttons for performing image processing and other various kinds of signal processing. Since a user can manipulate the buttons 113 while monitoring the liquid crystal panel 112, operational errors are effectively prevented.

The cartridge attachment unit 120 illustrated in FIGS. 1 and 2 can house/accommodate ink cartridges 121 in such a manner that each of the ink cartridges 121 can be attached thereto in an easily detachable manner. Each of the ink cartridges 121 shown in FIGS. 3 and 4 contains ink of a certain printing color. In the present embodiment of the invention, the ink cartridges 121 support nine printing colors, which will be described later. A cartridge cover 122, which has a letter L shape of cross section, sheathes the cartridge attachment unit 120. The cartridge cover 122 is attached to the ink-jet printer 100 in such a manner that it can turn in a direction shown in FIGS. 1 and 2 by the arrow “b” around its rotation axis provided at the rear end thereof. After lifting the cartridge cover 122 so as to expose the cartridge attachment unit 120, a user can perform replacement and other work on the ink cartridges 121 in an easy manner, resulting in an improved working efficiency.

The first rear paper-feed unit 130 is provided for automatic feeding of sheet(s) of paper (ASF/Automatic Sheet Feed). As illustrated in FIGS. 1 and 2, the first rear paper-feed unit 130 is provided with a first paper-support member 132 having a four-tiered structure. The first paper-support member 132 has double functions of opening/closing a first paper-feed port 131 and supporting a single sheet or plural sheets of paper to be fed. The first paper-feed port 131 is configured as an upward rectangular hole. The first paper-support member 132 is attached to the ink-jet printer 100 in such a manner that it can turn in a direction shown in FIGS. 1 and 2 by the arrow “c” around its rotation axis provided at the rear end thereof. The first rear paper-feed unit 130 accepts comparatively thin types of paper. For example, the first rear paper-feed unit 130 can feed normal plain paper having a thickness of not less than 0.08 mm and not more than 0.27 mm, photo paper having a thickness within the same range (i.e., from 0.08 mm to 0.27 mm inclusive), and/or any equivalent print target medium).

Before starting the print operation of the ink-jet printer 100, a user raises the first paper-support member 132 while hooking their fingers into a finger-hold hole 132a, which is formed in the proximal center region of the first paper-support member 132 as shown in the drawing, to pull out the multi-tier portion thereof. Since the pre-print first-paper-support-member setting can be completed by such a simple mechanical manipulation, the above-described structure eliminates the burden of keeping a detached paper support member aside or other similar bothersome work, which must be done in a case where a removable paper support structure is adopted. In addition, the first paper-support member 132 can support various sizes of paper because it has the above-mentioned multi-tiered structure. After completion of printing jobs, the user can close the first paper-feed port 131 by pushing the multi-tier portion of the first paper-support member 132 inward. Therefore, it is possible to block any otherwise possible infiltration of dust into the body of the ink-jet printer 100 when it is not used. In addition thereto, it is further possible to retract/house the first paper-support member 132 in a space-saving manner.

The second rear paper-feed unit 140 is provided for manual feeding of a sheet of paper. As illustrated in FIG. 2, the second rear paper-feed unit 140 is provided with a second paper-support member 142 having a two-tiered structure. The second paper-support member 142 has double functions of opening/closing a second paper-feed port 141 and supporting a single sheet of paper to be fed. The second paper-feed port 141 is configured as a rearward rectangular hole. The second paper-support member 142 is attached to the ink-jet printer 100 in such a manner that it can turn in a direction shown in FIG. 2 by the arrow “d” around its rotation axis provided at the lower end thereof. The second rear paper-feed unit 140 accepts a certain type of paper having a thickness that is too thick to be fed at a paper transport angle offered by the first rear paper-feed unit 130. For example, the second rear paper-feed unit 140 can feed printing paper, dedicated paper, or the like, having a thickness within the range from, approximately, 0.29 mm to 0.48 mm. Since the first rear paper-feed unit 130 is provided for automatic paper feeding (ASF) as mentioned earlier, a paper-feed roller 82, which picks up sheets of paper automatically, could cause a paper-feed malfunction due to any reduced friction, or paper slippage, that occurs when any paper dust settles on the paper-feed roller 82. For this reason, it is highly recommended to feed such a type of paper as one that is susceptible to a paper-feed malfunction attributable to the settlement of paper dust in a manual paper-feed operation by means of the second rear paper-feed unit 140. Examples of such paper includes but not limited to Velvet Fine Art Paper having a thickness of approximately 0.48 mm, and Ultra Smooth Fine Art Paper having a thickness of approximately 0.46 mm.

Before starting the print operation of the ink-jet printer 100, a user presses the second paper-support member 142 down while hooking their fingers onto the upper portion thereof shown in the drawing, to pull out the multi-tier portion thereof. Since the pre-print second-paper-support-member setting can be completed by such a simple mechanical manipulation, the above-described structure eliminates the burden of keeping a detached paper support member aside or other similar bothersome work, which must be done in a case where a removable paper support structure is adopted. In addition, the second paper-support member 142 can support various sizes of paper because it has the above-mentioned multi-tiered structure. After completion of printing jobs, the user can close the second paper-feed port 141 by pushing the multi-tier portion of the second paper-support member 142 inward. Therefore, it is possible to block any otherwise possible infiltration of dust into the body of the ink-jet printer 100 when it is not used. In addition thereto, it is further possible to retract/house the second paper-support member 142 in a space-saving manner.

The paper-eject unit 150 is, as illustrated in FIG. 1, provided with a two-tiered stacker 152 that is made up of a first stacker 51 and a second stacker 52 illustrated in FIG. 3. The stacker 152 has double functions of opening/closing a paper-eject port 151 and stacking a single sheet or plural sheets of paper to be ejected. The paper-eject port 151 is configured as a frontward rectangular hole. The first stacker 51 is attached in such a manner that it can turn in a direction shown in FIG. 1 by the arrow “e” around its rotation axis provided at the front end of the second stacker 52. The second stacker 2 is attached to the ink-jet printer 100 in such a manner that it can perform a translation operation (i.e., parallel displacement or parallel movement) in an inclined upward/downward direction with respect to the paper-eject port 151 so that it project forward/retract backward.

Before starting the print operation of the ink-jet printer 100, a user hooks their fingers onto the upper portion of the first stacker 51 and then opens the paper-eject port 151 by turning the first stacker 51 toward themselves. Next, the user pulls out the first stacker 51 while pinching the front end thereof with their fingers. Subsequently, the user moves the second stacker 52 in an inclined upward direction in a translation operation so that it projects frontward. Since the pre-print stacker setting can be completed by such a simple mechanical manipulation, the above-described structure eliminates the burden of keeping detached stackers aside or other similar bothersome work, which must be done in a case where a removable stacker structure is adopted. In addition, since the stacker 152 has the multi-tiered structure as mentioned above, various sizes of paper to be ejected can be stacked thereon. Moreover, the user can take out ejected paper easily because print-completed paper is always ejected from the front side of the ink-jet printer 100. After completion of printing jobs, the user can translate (i.e., move in a parallel manner) the second stacker 52 in an inclined downward direction by pushing the front end of the first stacker 51 inward so that the second stacker 52 retracts backward. Thereafter, the user closes the paper-eject port 151 by turning the first stacker 51 away from themselves while supporting the first stacker 51 with their fingers. Therefore, it is possible to block any otherwise possible infiltration of dust into the body of the ink-jet printer 100 when it is not used. In addition thereto, it is further possible to retract/house the stacker 152 in a space-saving manner.

The front paper-feed unit 160 is provided for manual feeding of a sheet of paper. As illustrated in FIG. 3, the front paper-feed unit 160 has a paper-feed tray 161 that is provided over the stacker 152 of the paper-eject unit 150. The paper-feed tray 161 is attached to the ink-jet printer 100 in such a manner that it can move horizontally with respect to the paper-eject port 151. The front paper-feed unit 160 accepts comparatively thick types of paper that cannot be deflected during transport due to its thickness. For example, the front paper-feed unit 160 can feed mat-board paper having a thickness of approximately 1.2 mm, though not limited thereto.

Before starting the print operation of the ink-jet printer 100, a user can release the stopper of the paper-feed tray 161 so as to make it protrude through the paper-eject port 151 by pushing the front end of the paper-feed tray 161 slightly in an inward direction. After completion of printing jobs performed by the ink-jet printer 100, the user can activate the stopper of the paper-feed tray 161 so as to have it retracted and housed into the paper-eject port 151 by pushing the front end of the paper-feed tray 161 again slightly in an inward direction. Such a structure improves the space efficiency of the paper-feed tray 161.

The discarded ink collection unit 170 accommodates, as illustrated in FIGS. 1-3, a discarded ink tank 171 that reservoirs ink to be discarded in such a manner that the discarded ink tank 171 can be detached therefrom. The discarded ink tank 171 reservoirs drain ink or the like that is discarded at the time of cleaning of a recording head 202 and/or at the time of ink cartridge replacement. When the discarded ink tank 171 is filled with drain ink or the like, a user can easily replace the old ink tank 171 that is filled with drain ink, etc., with a new ink tank 171 in an easy manner just by pulling out the old one therefrom and then inserting the new one therein.

As illustrated in FIGS. 3 and 4, the paper transport unit 180 extends from the first rear paper-feed unit 130 and the second rear paper-feed unit 140 to the paper-eject unit 150. The paper transport unit 180 is provided with an automatic paper feeding mechanism 181, a paper transport mechanism 182, and a paper ejection mechanism 183. The automatic paper feeding mechanism 181 is, as illustrated in FIG. 4, provided with a hopper 81, the paper-feed roller 82, a retard roller 83, a paper-return lever 84, though not limited thereto. The hopper 81 functions to raise sheets of paper that are supported by the first paper-support member 132 in preparation for paper feeding. The paper-feed roller 82 functions to take out the sheets of paper that are raised by the hopper 81. The retard roller functions to separate a single sheet of paper from other sheets of paper that are fed together by the paper-feed roller 82. After paper-separation processing performed by the retard roller 83, the paper-return lever 84 returns the remaining sheets of paper to the hopper 81.

The hopper 81, which has a flat shape so that sheets of paper can be placed thereon, is provided substantially in parallel with a rear wall. The lower end of the hopper 81 lies in the proximity of the paper-feed roller 82. On the other hand, the upper end thereof lies in the proximity of the top portion of the rear wall. A compression spring that is not shown in the drawing is attached to the hopper 81. Specifically, one end of the compression spring is attached to the rear wall whereas the other end thereof is attached to the reverse face (i.e., back) of the hopper 81 near the lower end thereof. With such a configuration, urged by the decompression force of the compression spring, the lower end of the hopper 81 can move with its upper end being the rotational center thereof.

The paper-feed roller 82 is configured to have a letter D cross-sectional shape because a part thereof is cut out therefrom. The paper-feed roller 82 is provided in the proximity of the lower end of the hopper 81. The paper-feed roller 82 rotates intermittently so as to feed the sheets of paper raised by the hopper 81 by means of a friction force. The retard roller 83 is configured in such a manner that it can contact the paper-feed roller 82. When a plurality of sheets of paper is fed together by the paper-feed roller 82, the retard roller 83 functions to separate the uppermost sheet of paper from the remaining sheets thereunder by means of a friction force. The hook-nail-shaped paper-return lever 84 is provided in the proximity of the paper-feed roller 82. The paper-return lever 84 hooks the second sheet from the top and thereunder, which are separated from the uppermost one by the retard roller 83, onto its hook nails so as to return the hooked remaining sheets of paper to the hopper 81.

As illustrated in FIG. 4, the paper transport mechanism 182 is mainly made up of a master paper-transport roller 85 and a slave paper-transport roller 86. The master paper-transport roller 85 transports paper in the sub-scan direction in synchronization with recording operation. The master paper-transport roller 85 is provided at the upstream side of a platen 203. The master paper-transport roller 85 supports the sheet of paper that is fed by the paper-feed roller 82 in cooperation with the slave paper-transport roller 86 in a sandwiching manner. In that way, the master paper-transport roller 85 and the slave paper-transport roller 86 feed the sheet of paper to the platen 203.

The paper ejection mechanism 183 is, as illustrated in FIG. 4, provided with a paper-eject roller 87, a first serrated roller 88a, and a second serrated roller 88b, though not limited thereto. The first serrated roller 88a is provided at the downstream side of the platen 203. The second serrated roller 88b and the paper-eject roller 87 are opposed to each other at the downstream side of the first serrated roller 88a. The paper that has passed through the platen 203 is transported by the first serrated roller 88a and then sandwiched between the second serrated roller 88b and the paper-eject roller 87 to be ejected onto the stacker 152. The same single holding member that is not shown in the drawing holds the first serrated roller 88a and the second serrated roller 88b.

As illustrated in FIG. 4, the control unit 190 is provided with a main substrate 191 that constitutes a printer controller. Various kinds of control elements (i.e., devices) that are not shown in the drawing such as CPU, ROM, RAM, ASIC, and the like, memory elements, and other circuit elements are mounted on the main substrate 191. Having such a variety of elements, the main substrate 191 controls the paper transport unit 180, the recording unit 200, or the like, which constitute a printer engine.

As illustrated in FIG. 4, the recording unit is provided with, though not limited thereto, a carriage 201 that travels in the main-scan direction in synchronization with recording operation, the recording head 202 that discharges ink in synchronization with recording operation, the platen 203 that holds a sheet of paper during a recording operation in a flat condition. The platen 203 is provided with a liquid receiving device (i.e., liquid catcher, or liquid receiver) 220, which constitutes a characterizing portion of the invention. As illustrated in FIG. 3, the carriage 201 is mounted above the platen 203 in such a manner that a carriage guide axis 206 penetrates through the carriage 201. The carriage 201 is fixed to a carriage belt 205. When a carriage motor, which is not shown in the drawing, drives the carriage belt 205, the carriage 201 reciprocates as guided along the carriage guide axis 206 in accordance with the movement of the carriage belt 205.

The recording head 202 is, as illustrated in FIG. 4, mounted on the carriage 201 in such a manner that a certain clearance is left between the recording head 202 and the platen 203. The recording head 202 can discharge, in addition to two types of black ink such as photo black ink and mat black ink, seven types of color ink such as yellow ink, cyan ink, light cyan ink, magenta ink, light magenta ink, gray ink, and red ink. The recording read 202 has pressure generation chambers (i.e., compartments) and nozzle orifices (i.e., openings or holes) formed in the nozzle plate. The nozzle orifices are in communication with the pressure generation chambers. A predetermined pressure is applied to the pressure generation chambers in such a state that the pressure generation chambers retain ink. By means of pressure applied thereto, the recording head 202 discharges ink drops each of which having a controlled droplet size through the nozzle orifices onto a print target paper. Next, with reference to the accompanying drawings, a detailed explanation is given of the platen 203 having the liquid receiving device 220, which constitutes a characterizing portion of the invention.

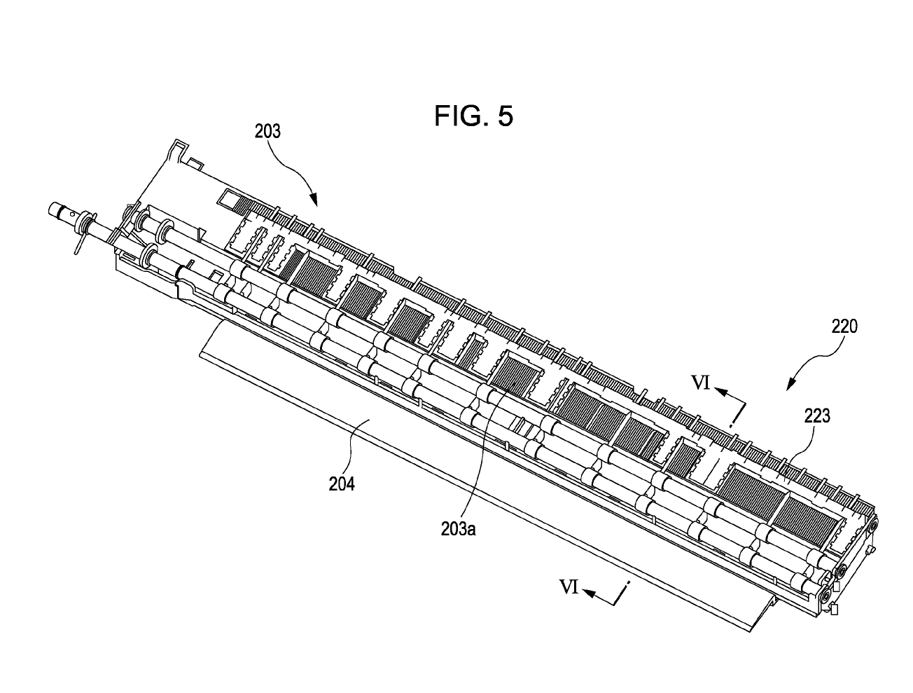

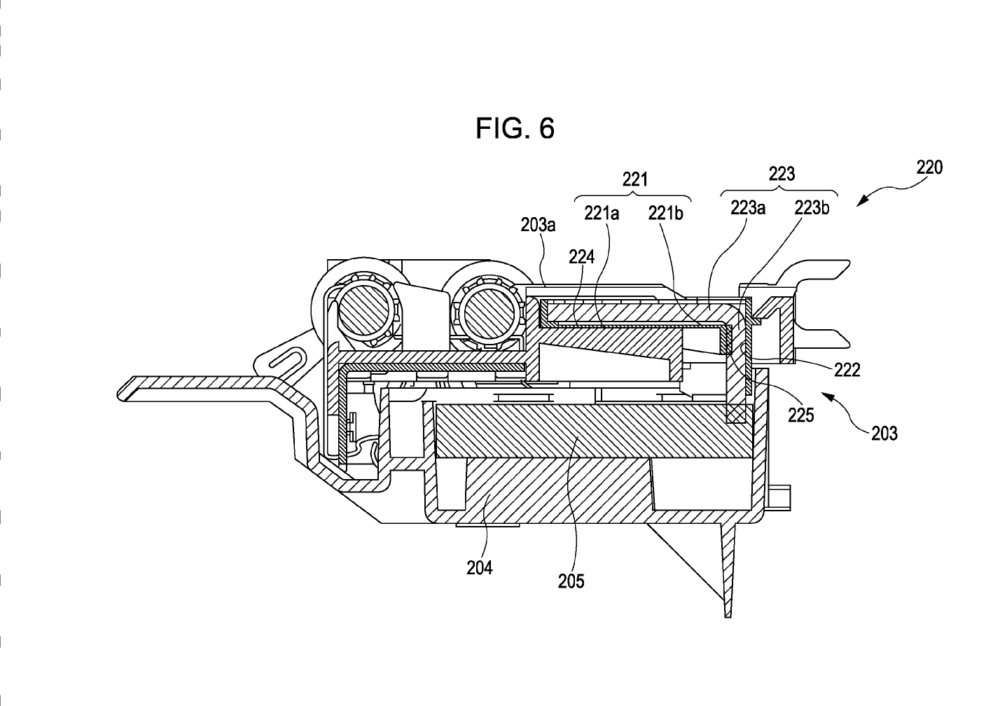

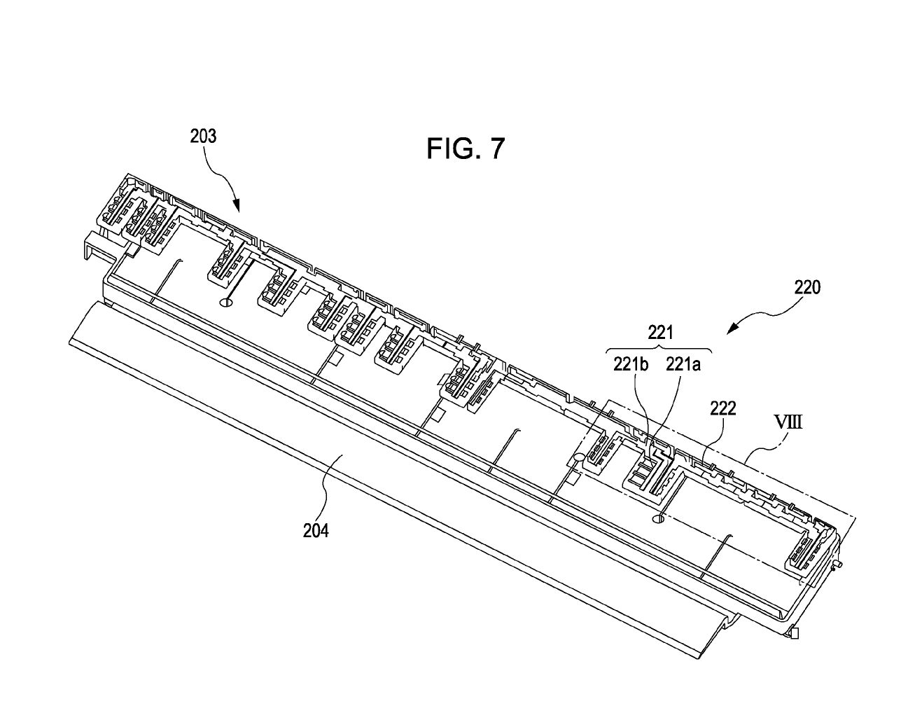

FIG. 5 is a perspective view that schematically illustrates an example of the platen 203 and its peripheral portion viewed from the upstream side of a paper transport channel. FIG. 6 is a sectional view taken along the line VI-VI of FIG. 5. FIG. 7 is a perspective view that schematically illustrates an example of the essential part of the liquid receiving device 220 described above. The platen 203 is provided between the master paper-transport roller 85 and the paper-eject roller 87 in such a manner that the platen 203 is opposed to the recording head 202. A discarded ink collection box (discarded liquid collection box) 204 that collects discarded ink is provided under the platen 203. The platen 203 is configured to have the shape of an elongated flat plate that is substantially rectangular. The platen 203 extends in the main-scan direction. The length of the platen 203 is slightly greater than the width of the maximum size of paper on which the ink-jet printer 100 can perform recording. Ribs 203 stand on the platen 203. The ribs 203 support paper that is transported thereto. The platen 203 is provided with an ink-receiving portion (liquid receiving portion) 221 and an ink drain portion (liquid drain portion) 222. The ink-receiving portion 221 receives ink drops that fall outside the edges of paper at the time of marginless recording. The ink drain portion 222 drains the ink that flows from the ink-receiving portion 221 into the ink drain portion 222 to the discarded ink box 204. An Ink absorber 223 is provided on the ink-receiving portion 221 and the ink drain portion 222. The ink-receiving portion 221, the ink drain portion 222, and the ink absorber 223 described above constitute the liquid receiving device 220.

The ink-receiving portion 221 is configured as a comb-shaped recess portion (i.e., groove hole portion) that is made up of a plurality of comb-teeth portions (arrangement area, a first liquid receiving portion) 221a and a comb-spine portion (arrangement area, a second liquid receiving portion) 221b. The teeth of the comb (221a) are arrayed at predetermined intervals along the main-scan direction. Each of the teeth of the comb (221a) extends in the sub-scan direction from the spine thereof (221b) that lies at the upstream side of the paper transport channel. The ink absorber (liquid absorber) 223 that soaks up the ink drops caught by the ink-receiving portion 221 is detachably attached to the ink-receiving portion 221. The ink drain portion 222 is configured as through holes each having a substantially rectangular shape. These through holes are arrayed at predetermined intervals along the main-scan direction on the bottom of the comb-spine portion 221b that constitutes a part of the ink-receiving portion 221. The ink absorber 223 is detachably inserted in the ink drain portion 222. In other words, the portion 223a of the ink absorber 223 that is fixed to the ink-receiving portion 221 (first liquid absorber) is formed in the shape of a comb, whereas the portion 223b of the ink absorber 223 that is inserted in the ink drain portion 222 (second liquid absorber) is formed in the shape of teeth of a comb that are substantially perpendicular to the comb portion 223a.

The comb-teeth portions 221a of the ink-receiving portion 221 are arrayed locally at positions corresponding to the left edge and right edge of each of recordable sizes of paper. The main function of the comb-teeth portions 221a of the ink-receiving portion 221 is to catch ink drops that fall outside the left edge and right edge of each of recordable sizes of paper at the time of left/right marginless printing. The comb-spine portion 221b of the ink-receiving portion 221 is arranged to extend along the width direction of a sheet of paper. The main function of the comb-spine portion 221b of the ink-receiving portion 221 is to catch ink drops that fall outside the top edge and bottom edge of paper at the time of top/bottom marginless printing. The plurality of ribs 203a each of which extends in the paper transport direction are arrayed at predetermined intervals on the platen 203 between the comb-teeth portions 221a of the ink-receiving portion 22. Each of the ribs 203a has a trapezoidal cross-sectional shape taken along the main-scan direction. These “rail-like” ribs 203a support the rear surface of a sheet of paper that is transported thereto. According to the configuration described above, the comb-teeth portions 221a and the comb-spine portion 221b of the ink-receiving portion 221 makes it possible to improve ink collection efficiency at the time of marginless recording, in particular, when marginless printing is performed on the entire surface of a sheet of paper. In addition, since the ribs 203a provide a clearance between the ink absorber 223 and a sheet of paper, it is possible to effectively prevent the paper from being stained by ink.

In the configuration described above, ink drops that have fallen outside of the left/right edges and the top/bottom edges of a sheet of paper at the time of marginless printing is caught/absorbed by the comb portion 223a of the ink absorber 223 that is fixed to the comb-teeth portions 221a and the comb-spine portion 221b of the ink-receiving portion 221. The ink flows on the bottom of the comb-teeth portions 221a and the comb-spine portion 221b of the ink-receiving portion 221, and then flows into the comb-teeth portion 223b of the ink absorber 223 that is inserted in the ink drain portion 222. Finally, the ink is drained to the discarded ink collection box 204 and then absorbed by an ink absorber 205 provided thereat. As a material of the ink absorbers 223 and 205, a porous material having an excellent ink absorption property, invulnerability against ink (that is, having an excellent ink resistance), and excellent elasticity and flexibility is preferable. An example of such a material includes spongy polyurethane, polyethylene, or the like. As has already been described in the Background Art, recently, as the size of print target paper is becoming larger, so does the amount of ink drops that fall outside the edges of the print target paper. Accordingly, it is difficult even for a solvent-applied ink absorber to successfully absorb a large amount of waste ink drops. Therefore, there is a possibility that the drained/discarded ink dries on the surface of the ink absorber to cause undesirable settlement thereon. In order to address such a problem, the liquid receiving device 220 according to the present embodiment of the invention provides a technical solution that is explained in detail below while making reference to the accompanying drawings.

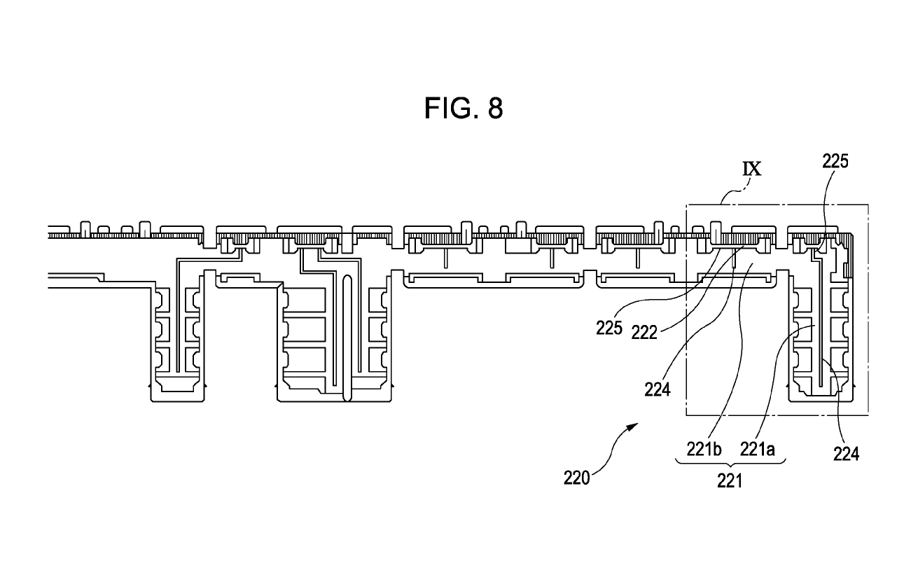

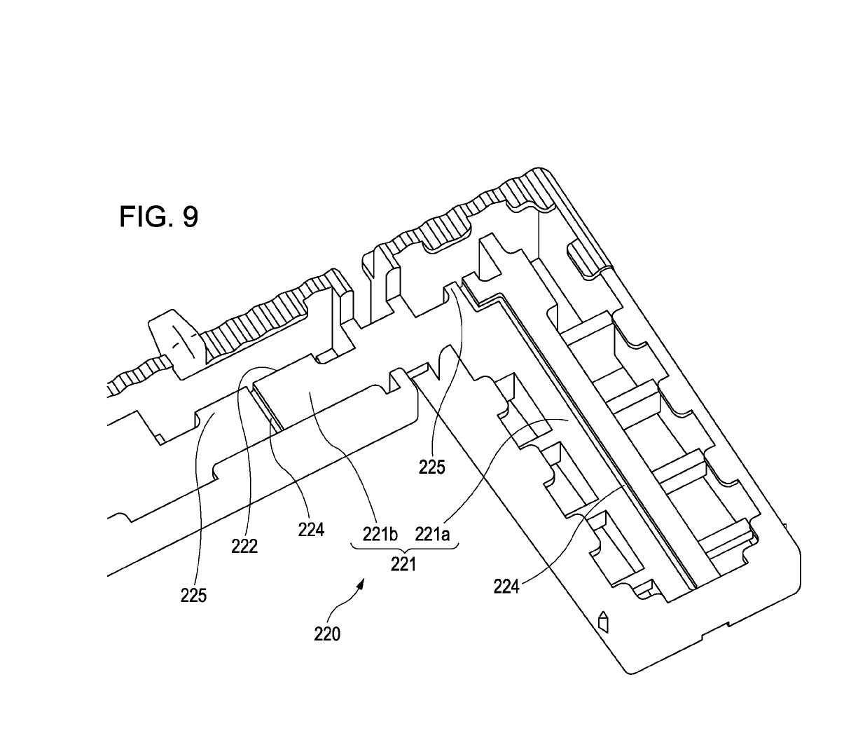

FIG. 8 is an enlarged plane view of the portion VIII illustrated in FIG. 7. FIG. 9 is an enlarged perspective view of the portion IX illustrated in FIG. 8. Grooves (liquid guiding structure) 224 that canalize (i.e., guide) the ink caught by the ink-receiving portion 221 to the ink drain portion 222 are formed on the bottom of the ink-receiving portion 221 that constitutes a part of the liquid receiving device 220. The grooves 224 are formed in such a manner that they extend linearly in the direction in which ink is guided. That is, the groove 224 is formed in parallel with the left/right edges of a sheet of paper toward the substantially center of each ink drain portion 222 on the bottom of the comb-teeth portions 221a and the comb-spine portion 221b that constitute the ink-receiving portion 221. With such a configuration, it is possible to effectively canalize ink so that it flows from the ink receiving portion 221 to the ink drain portion 222 through the inner wall of the groove 224. In addition thereto, it is also possible to obtain a substantially uniform flow of ink viewed along the paper width direction so as to improve ink collection efficiency.

A projecting portion (absorber compression portion) 225 that has the shape of a rectangular parallelepiped is formed in the inner surface of the ink drain portion 222. The projecting portion 225 collapses the comb-teeth portion 223b of the ink absorber 223 so that the comb-teeth portion 223b of the ink absorber 223 is compressed. The projecting portion 225 is provided on the side surface of the ink drain portion 222 at the downstream side of the paper transport channel. The projecting portion 225 is provided in such a manner that it can press at least the center of the side surface of the comb-teeth portion 223b of the ink absorber 223 or in the neighborhood thereof. An end portion of the groove 224 lies at the center, or in the neighborhood thereof, of the upper face of the projecting portion 225. With such a configuration, it is possible to compress the comb-teeth portion 223b of the ink absorber 223 in a substantially uniform manner. In addition thereto, it is possible to guide ink to the substantially central position of the compressed comb-teeth portion 223b of the ink absorber 223. Therefore, it is possible to improve ink absorption efficiency of the ink absorber 223.

According to the exemplary configuration of the liquid receiving device 220 described above, ink travels through the groove 224, which facilitates the formation of an initial ink flow channel. In addition thereto, since ink flows in the groove 224, it is possible to prevent any undesirable spread of the ink. Therefore, it is possible to improve the ink-guiding capability of the ink-receiving portion 221. Since the projecting portion 225 increases the density of the comb-teeth portion 223b of the ink absorber 223, it is possible to improve the ink-sucking capability of the ink drain portion 222 due to a capillary phenomenon; and in addition, it is further possible to reduce ink retention capability thereof so as to facilitate the drainage of the spilt ink to the ink absorber 205 provided in the discarded ink collection box 204 due to its “water head” (stress) value. In the exemplary embodiment of the invention, the grooves 224 are formed on the bottom of the of the comb-teeth portions 221a and the comb-spine portion 221b that constitute the ink-receiving portion 221. Notwithstanding the foregoing, the invention is not limited to such a configuration. For example, a ridgeline whose cross-sectional shape is configured as a chevron may be formed in place of the groove 224. In such an alternative configuration, it is possible to guide ink from the ink-receiving portion 221 to the ink drain portion 222 along the ridgeline.

In the embodiment described above, the invention is explained while exemplifying an ink-jet printer as a typical example of a liquid ejecting apparatus. Notwithstanding the foregoing, the invention is directed to various kinds of liquid ejecting apparatuses; and therefore, needless to say, the invention is also applicable to a variety of liquid ejecting apparatuses that eject liquid other than ink. For example, the invention is also applicable to a facsimile machine, a copying machine, or the like. That is, in addition to an ink-jet printer described in the above exemplary embodiment, a liquid ejecting apparatuses to which the invention is applicable encompasses a wide variety of other types of apparatuses that eject liquid, which varies from one application to another and therefore not limited herein, in place of ink onto a liquid ejection target medium. Examples of a liquid ejecting apparatus according to the invention include, without any limitation thereto: an apparatus that is provided with a color material ejection head that is used in the production of color filters for a liquid crystal display device or the like; an apparatus that is provided with an electrode material (i.e., conductive paste) ejection head that is used for electrode formation for an organic EL display device, a surface/plane emission display device (FED), and the like; an apparatus that is provided with a living organic material ejection head used for production of biochips; and an apparatus that is provided with a sample ejection head functioning as a high precision pipette.

What is claimed is:

1. A liquid receiving device comprising:
a liquid receiving portion that receives discharged liquid; and
a liquid drain portion that drains the liquid that has flowed from the liquid receiving portion into the liquid drain portion;
wherein the liquid receiving portion has an arrangement area where a first liquid absorber that absorbs the discharged liquid is arranged, the arrangement area having a liquid guiding structure that guides the liquid absorbed by the first liquid absorber to the liquid drain portion; and
the liquid drain portion has a second liquid absorber that absorbs the liquid that has flowed from the liquid guiding structure, the liquid drain portion having an absorber compression portion that compresses at least a part of the second liquid absorber.

2. The liquid receiving device according to claim 1, wherein the liquid guiding structure is configured as a groove or a ridgeline.

3. The liquid receiving device according to claim 1, wherein the absorber compression portion can press at least the center of the liquid absorber or in the neighborhood thereof.

4. A liquid ejecting apparatus that ejects liquid onto a liquid ejection target medium, the liquid ejecting apparatus being provided with the liquid receiving device according to claim 1.
